(19) United States
(12) Patent Application Publication
(10) Pub. No.: US 2006/0077803 A1
(43) Pub. Date: Apr. 13, 2006

(54) Method of adjusting a writing focus in an optical disc drive

(75) Inventor: Chien-Chih Weng, Taipei (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/211,732

(22) Filed: Aug. 26, 2005

(30) Foreign Application Priority Data
Aug. 27, 2004 (TW) 93125838

(51) Int. Cl. G11B 7/00

(52) U.S. Cl. 369/44.27; 369/44.25; 369/44.34

(57) ABSTRACT

A method of adjusting a writing focus in an optical disc drive is disclosed. At first, the focus lens of the optical pick-up head is actuated make the focusing point of a laser beam focused on a number of predetermined positions, and a laser beam with a constant power is provided to write trial write data when the focusing point is in the predetermined positions. The trial write data is read and one of the predetermined positions is selected as the writing focus according to the reproduced trial write data.

This application claims the benefit of Taiwan application Serial No. 93125838, filed Aug. 27, 2004, the subject matter of which is incorporated herein by reference.

### BACKGROUND OF THE INVENTION

1. Field of the Invention

The invention relates in general to method of adjusting a writing focus in an optical disc drive, and more particularly to a method of locating an optimum writing focus in an optical disc drive.

2. Description of the Related Art

Normally, when the power of an optical disc drive is switched on, the optical disc drive would immediately perform a start up procedure. The start up procedure includes initializing system parameters, compensating signal bias, determining the types of the disc and making the laser beam of the optical pick-up head focused on the disc. After completing the start up procedure, the optical disc drive enters a stand-by state and awaits the commands outputted from the host.

When the optical disc drive receives a write data command from the host, the optical disc drive would sequentially perform the following steps:

Accessing data from the host, that is, to store the to-be-written data in a dynamic random access memory (DRAM) of the optical disc drive.

Adjusting the optimum writing power of the optical pick-up head, which is also called “optimum power control” (OPC). The optimum writing power of the optical pick-up head has much to do with the quality and the manufacturing process of the disc. In the present step, the optical pick-up head uses a laser beam with different powers to write into the power calibration area (PCA) of the disc. The optical pick-up head uses the laser beam with read power to read the trial write data, and obtains the optimum write power of the laser beam by calculating the signals received when reading the trial write data.

Seeking position. The seeking servo would perform seeking first. That is, actuating the optical pick-up head to the target track instructed by the seeking servo. Data writing starts once the seeking servo confirms that the optical pick-up head is at the target track.

The above step of making the laser beam focused on the disc and OPC is an important factor crucial to the writing quality of the optical disc drive. The writing quality of the disc would easily be deteriorated if the laser beam emitted by the optical pick-up head fails to focus on the disc or if the optimum laser power of writing is not obtained in the OPC step.

With the rapid development of the optical storage technology, there are a variety of discs nowadays, such as CD-ROM, CD-R, CD-RW, hybrid CD, single-layered DVD, double-layered DVD, DVD-R, DVD+R, DVD-RW, DVD+RW, DVD-RAM and so forth. Discs of different varieties possess different data formats and physical characteristics, so the optical disc drive must be able to read data by various ways, such as by replacing the wave-length (CD: 780 nm; DVD: 650 nm) of the optical pick-up head laser beam or by amplifying some particular signals. Consequently, the optical structure of the optical disc drive is getting more and more complicated.

The optical pick-up head of the conventional optical disc drive capable of reading the DVD disc (inclusive of the CD disc) is normally equipped with the laser beams of two different wave-lengths. When reading/writing the DVD disc, the laser beam whose wave-length equals 650 nm is used; and when reading/writing the CD disc, the laser beam whose wave-length equals 780 nm is used.

Basically, the DVD laser beam whose wave-length is shorter would have smaller spot projected on the disc when going with a focus lens having a big numerical aperture (NA). Consequently, the track pitch of the DVD disc would be smaller, and more data volume can be written into the DVD disc than the CD disc. The DVD optical system (inclusive of DVD laser beam, focus lens, beam splitter and optical grating) would have higher sensitivity, and a slight vibration or tilting would affect the DVD optical system, deteriorating the reading/writing quality of the DVD.

Besides, the aberrations caused by the optical object lens module of the DVD optical system, such as optical path aberration, non-point aberration and spherical surface aberration for example, also affect the focusing accuracy greatly. That is why the focusing quality is so important in the DVD optical system.

Conventional optical disc drive determines whether a laser beam is focused on the disc according to the focusing error signal or the quality of the wobble signal. The focusing mechanism is elaborated below.

FIG. 1 is a diagram of the focusing mechanism of the optical pick-up head of the optical disc drive. A laser diode 1 is used to generate a laser beam; the laser beam with the read power is focused on a focusing point 9 after passing through a beam splitter 3 and an object lens 5. A focus actuator 11 controls the object lens 5 to move upward/downward so as to change the position of the focusing point 9. The reflective light generated when the focusing point 9 reaches the disc 7 is guided to a photo-detector 13 through the beam splitter 3. The optical signal such as focusing error signal, radio frequency signal (RF Signal), radio frequency level signal (RF level signal) or sub-beam add signal which controls the focusing of the laser beam can be obtained from the photo-detector 13.

Referring to FIG. 2, a diagram of a conventional method of using a focusing error signal to determine the focusing is shown. The focusing open loop controls the searching of focusing, enabling the focusing point to get closer and closer to the disc 38, that is, the focusing point moves along a direction 56. Collecting and recording the focusing error signals, an S-curved diagram as shown in FIG. 2 is formed. When the focusing point is away from the disc 38 in an infinite distance, the reflective light fades out and the focusing error signal turns feeble. When the focusing point gradually approaches the various layers of the disc 38, take the first recording layer 42 for instance, the focusing error signal would gradually detect the reflective light beam, and the area of the positive peak contains a maximum focusing error FE_PK1. As the focusing point continues to get closer to the first recording layer 42, the focusing error starts to decrease and generates the focusing error signal with a zero-crossing point 52 when the focusing point is on the recording layer 42. Afterwards, the focusing point still continues to approach the vicinity of the first recording layer 42, while the focusing error signal gradually returns to zero after passing a minimum FE_BT1, forming an S-curve.

As shown in FIG. 2, when the focusing point passes through the surface of three different layers, namely a plastic layer 40, a first recording layer 42 and a second recording layer 44, three types of S-shaped curves, namely S0, S1 and S2 would occur respectively. Normally the optical disc drive uses the focusing error signal and an assistant RF level signal to determine whether the laser beam has been focused or not. Therefore, when the optical disc drive detects that the focusing point is at the zero-crossing points (that is, 52 and 54) of the S-curve and that the amplitude of vibration of the RF level signal (RFL_PK1 and PFL_PK2) is larger than a threshold, the optical disc drive would determine that the laser beam has been focused on the recording layer. Then, the optical disc drive would proceed to the subsequent steps of position seeking and data writing.

However, the conventional method of using the zero crossing point and RF level signal of respective S-curves to determine whether the laser beam is focused or not is not applicable to DVD optical system. This is because the DVD optical system requests a higher standard of focusing accuracy than the CD optical system does, and if the DVD optical system and the CD optical system adopt the same focusing mechanism, the writing quality of the DVD disc is normally unsatisfactory. Therefore, a method capable of making a laser beam focused on the disc accurately to improve the unsatisfactory writing quality of the DVD disc.

### SUMMARY OF THE INVENTION

The object of the invention is to provide a method of adjusting a writing focus in an optical disc drive to resolve the problem of unsatisfactory writing quality caused by inaccurate focusing of the DVD optical system.

The invention provides a method of adjusting a writing focus in an optical disc drive. At first, the focus lens of the optical pick-up head is actuated make the focusing point of a laser beam focused on a number of predetermined positions, and a laser beam with a constant power is provided to write trial write data when the focusing point is in the predetermined positions. The trial write data is read and one of the predetermined positions is selected as the writing focus according to the trial write data.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram of the focusing mechanism of the optical pick-up head of the optical disc drive;

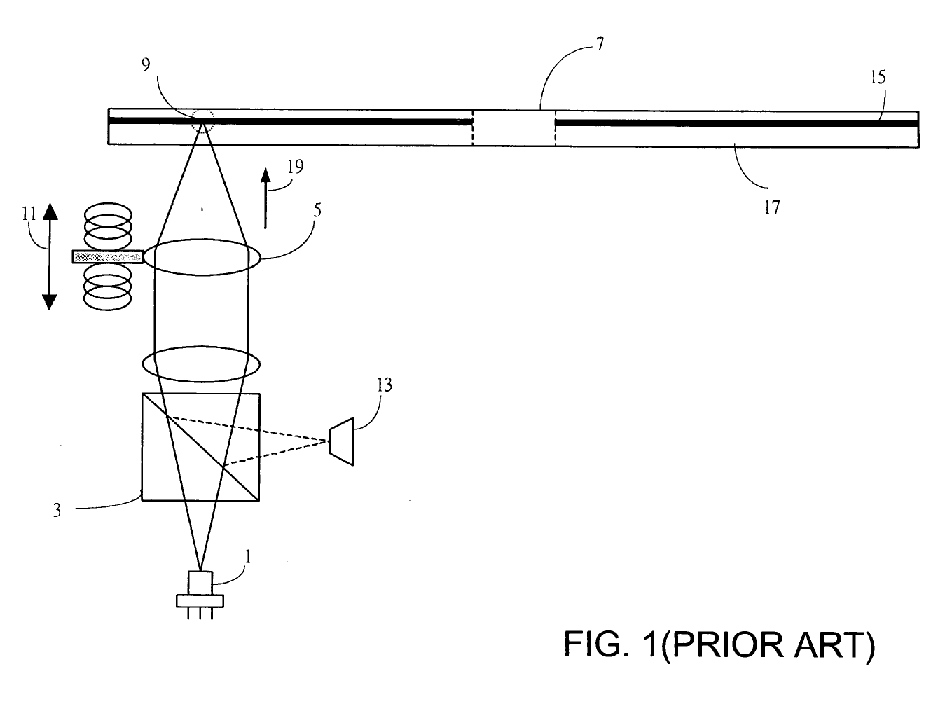

FIG. 2 is a diagram of a conventional method of using a focusing error signal to determine the focusing condition of the laser beam;

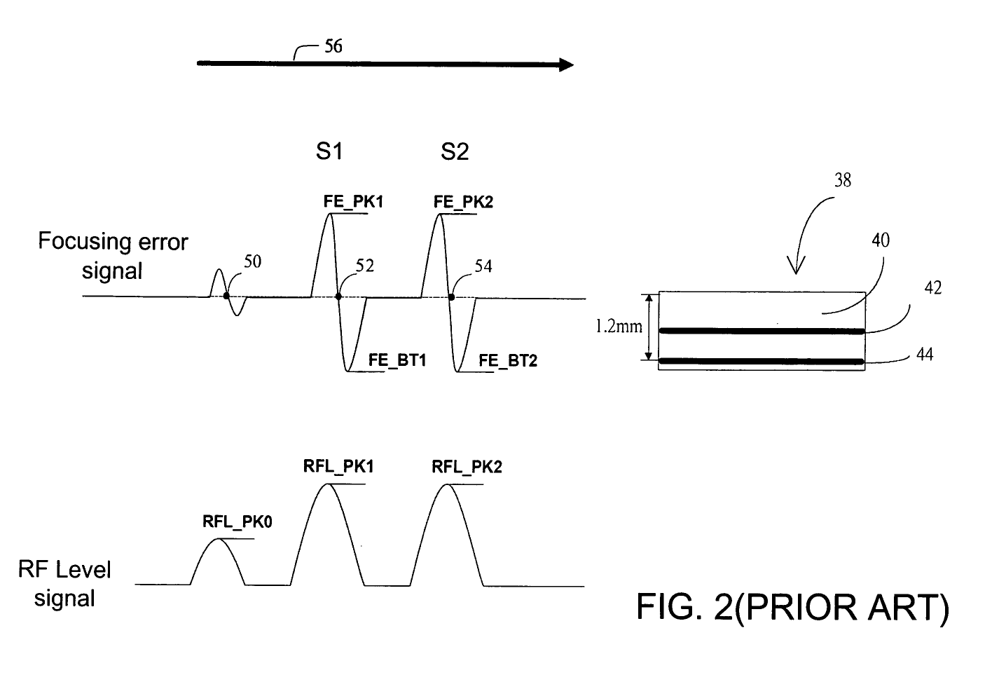

FIG. 3 is a flowchart of a method of adjusting a writing focus in an optical disc drive according to the invention; and

FIG. 4 is a diagram of focusing the laser beam on a disc.

### DETAILED DESCRIPTION OF THE INVENTION

In response to the high standard focusing accuracy required by the DVD optical system, the invention provides a method of adjusting a writing focus in an optical disc drive.

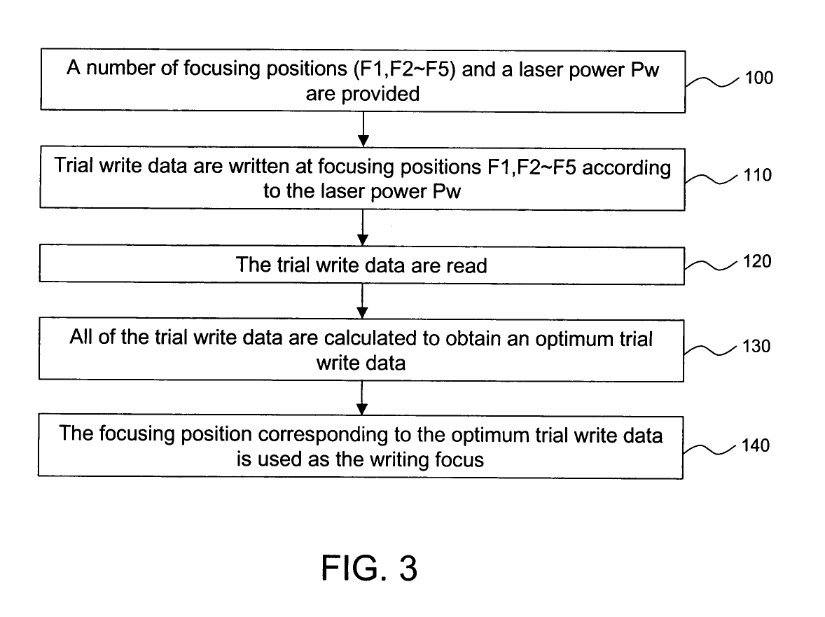

Referring to FIG. 3, a flowchart of a method of adjusting a writing focus in an optical disc drive according to the invention is shown.

Step 100: A number of focusing positions (F1, F2˜F5) and a laser power Pw are provided.

Step 110: Trial write data are written at focusing positions F1, F2˜F5 according to the laser power Pw.

Step 120: The trial write data are read.

Step 130: All of the trial write data are calculated to obtain an optimum trial write data.

Step 140: The focusing position corresponding to the optimum trial write data is used as the writing focus.

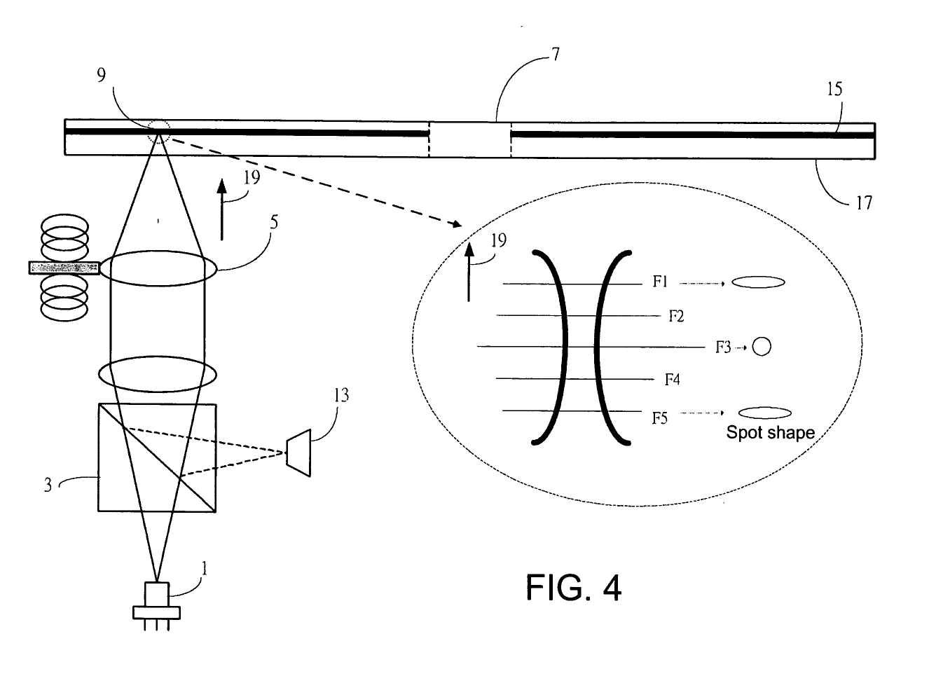

Normally the process is executed before the step of optimum power control (OPC). Referring to FIG. 4, a diagram of focusing the laser beam on a disc is shown. The actual laser beam has a fixed beam radius. When the laser beam is focused on the disc, the optimum situation occurs when the laser beam reaches the recording layer of the disc with the smallest spot size. This is illustrated in the diagram that the focusing point F3 is coplanar with the to-be-read recording layer.

At first, the optical disc drive selects a number of focusing positions (F1, F2˜F5) and provides a laser beam with a constant power Pw. Then, the seeking servo controls a focus actuator 11 to actuate an object lens upward/downward, enabling the focusing point of a laser beam to move from F1 to F5 sequentially. And an identical trial write data, such as a mark of 11 T length for instance, is written into the power calibration area (PCA) in each focusing position (step 110).

Then, reproduce all of the trial write data (step 120), and calculate all of the written trial write data to obtain an optimum trial write data (step 130).

In the above two steps, several alternative methods with regard to calculating to obtain the optimum trial write data are available. For example, an alternative method is to read the β value of all trial write data to obtain the optimum trial write data. The β value represents the asymmetry of the radio frequency signal (RF signal) obtained when the optical pick-up head reads data. The more asymmetric the RF signal is, that is, the larger the difference between the peak value of the RF signal when reading the land on the disc and the peak value of the RF signal when reading the pit, the larger the β value will be. In other words, the larger the β value, the deeper the pit is on the disc.

In the method, the β values of the reproducing result of all of the trial write data are calculated, and the largest β value is selected as the optimum trial write data of the trial write data. Referring to FIG. 4, when the focusing positions are respectively at F1, F3 and F5, the spot shape that the laser beam projects on the disc are illustrated in the diagram. The spot shape at the focusing positions F1 and F5 is oval-shaped. Compared with the spot shape at the focusing position F3, the spot shape at the focusing positions F1 and F5 is more slender. When writing a DVD disc having smaller track pitches on the disc, if the spot shape is too slender, the data would be easily written into an inappropriate write area such as a land or adjacent track pitches for instance, resulting in poor writing quality of the disc. This is because of the trial write data written under the same laser power Pw, the larger the β value the deeper the pit. Therefore, trial write data with the largest β value is selected as the optimum trial write data, which means the corresponding focusing position of the optimum trial write data is the optimum focusing point of writing. Therefore, the corresponding focusing position of the optimum trial write data (i.e. F3 at this case) is selected as the writing focus (step 140).

Besides, the β value is not the only index for selecting the optimum trial write data, the peak value of the pit of the RF signal can also be used as an index for selecting the optimum trial write data. Furthermore, by EFM (digital eight to fourteen modulated) decoding the trial write data directly, the failure rate in EFM decoding can also be used as an index for selecting the optimum trial write data.

The method of determining whether an optimum focusing point has been achieved according to the invention which differs significantly with that of the conventional method is disclosed below.

The conventional method of seeking the focusing point includes: projecting the laser beam with reading power on the disc, collecting the reflective light of the laser beam from the disc by the detector of the optical pick-up head; and then generating the optical signal for controlling the focusing operation by calculation. The focus actuator enables the focusing point of a laser beam to change, and then the optimum writing focus is determined according to the optical signals such as the focusing error signal or the RF level signal for instance.

However, the invention changes the focusing position of the laser beam, and at each focusing position, a laser beam with a constant write power is applied to write the trial write data into the power calibration area of the disc. Next, the β values of the trial write data are read, and the trial write data with the largest β value is selected as the optimum trial write data. At last, the focusing point corresponding to the optimum trial write data is selected as the writing focus.

Therefore, the invention directly uses a constant write power laser beam to write the trial write data, and obtains the optimum focus point according to the trial write data. The invention is advantaged by having a higher accuracy in seeking for the optimum writing focus than the conventional method which uses the read power laser beam to seek for the optimum writing focus. After the optimum focusing point is found, the focusing point is used as the writing focus. Generally, the write power of the laser beam differs widely with the read power of the laser beam. The photo-path of a laser beam under different powers may be different to a certain extent. Due to the high sensitivity of the DVD optical system, a satisfactory writing quality of the disc would not be obtained if the conventional method is used.

Moreover, the method according to the invention is implemented before the conventional OPC step, and writes trial write data into the power calibration area as is done in the OPC step. The optical disc drive obtains the optimum writing focus by amending the firmware alone without adding any extra elements, hence contributing to the saving of manufacturing costs.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of adjusting a writing focus in an optical disc drive, comprising the following steps of:
actuating a focus lens of an optical pick-up head to make the focusing point of a laser beam at a plurality of predetermined positions, and using the laser beam with a constant power to write a plurality of trial write data corresponding the predetermined positions;
reading the trial write data; and
selecting one of the predetermined positions as a writing focus according to the reproducing result of the trial write data.

2. The method according to claim 1, wherein the predetermined position corresponding to the trial write data with the largest β value is selected as the writing focus according to the reproducing result of the trial write data.

3. The method according to claim 1, wherein the predetermined position corresponding to the trial write data with the largest peak value of the pit of the RF signal is selected as the writing focus according to the reproducing result of the trial write data.

4. The method according to claim 1, wherein the predetermined position corresponding to the trial write data with the lowest failure rate of decoding is selected as the writing focus according to the reproducing result of the trial write data.

5. The method according to claim 1, wherein the laser beam with a constant power is a write power laser beam.

6. A method of adjusting a writing focus in an optical disc drive, comprising the following steps of:
providing a plurality of focusing positions and a laser power;
using the laser power to write a trial write data at each focusing position;
reproducing all of the trial write data;
calculating the reproduced trial write data to obtain an optimum trial write data; and
using the focusing position corresponding to the optimum trial write data as an optimum focusing position.

7. The method according to claim 6, wherein the trial write data with the largest β value is selected as the optimum trial write data.

8. The method according to claim 6, wherein the trial write data with the largest peak value of the pit of the RF signal is selected as the optimum trial write data.

9. The method according to claim 6, wherein the trial write data with the lowest failure rate of decoding is selected as the optimum trial write data.

10. The method according to claim 6, wherein the laser power is a write power.
